(19) United States
(12) Patent Application Publication
(10) Pub. No.: US 2026/0197510 A1
(43) Pub. Date: Jul. 9, 2026

(54) PRESENTATION, TIMING AND SCHEDULE MANAGEMENT FOR BROADCAST PROGRAMMING IN BETTING APPLICATIONS

(71) Applicant: SINCLAIR BROADCAST GROUP, LLC, Hunt Valley, MD (US)

(72) Inventor: Kevin James COTLOVE, Reisterstown, MD (US)

(73) Assignee: SINCLAIR BROADCAST GROUP, LLC, Hunt Valley, MD (US)

(21) Appl. No.: 19/200,015

(22) Filed: May 6, 2025

Related U.S. Application Data
(60) Provisional application No. 63/743,142, filed on Jan. 8, 2025.

(51) Int. Cl. H04N 21/2187; G06Q 50/34; H04W 4/029

(52) U.S. Cl. CPC H04N 21/2187; G06Q 50/34; H04W 4/029

(57) ABSTRACT

Disclosed herein are system, method, and computer program product aspects for implementing a live sporting events broadcasting system for a betting application. An aspect operates by determining a geolocation of the user device and transmitting a program information request to a scheduling server. The program information request indicates the geolocation. The aspect further operates by receiving scheduling information of a live event in the geolocation from the scheduling server and receiving a broadcast signal based on the scheduling information. Finally, the aspect displays the live event based on the broadcast signal and performs one or more betting operations using the betting application in association with the live event.

### CROSS-REFERENCE TO RELATED APPLICATIONS

This application claims benefit to U.S. Provisional Application No. 63/743,142, filed on Jan. 8, 2025, entitled “Presentation, Timing and Schedule Management for Broadcast Programming in Betting Applications,” which is incorporated herein in its entirety.

### BACKGROUND

Providing streaming services of live sporting events through the Internet is a complex task, especially in a new application on a user device, such as a mobile phone or tablet. The cost of getting a license for the live sporting events can be millions to billions of dollars given that the streaming rights are controlled by major leagues. In addition, some streaming rights are assigned exclusively to certain entities, thus making it nearly impossible to stream these events. On the other hand, it is possible to show live events via terrestrial broadcast systems, such as the Advanced Television Systems Committee (ATSC) 3.0 system. However, the current system may need to be improved to facilitate dynamic and accurate live sporting events broadcasting.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example live broadcast system, according to some aspects of the disclosure.

FIG. 2 illustrates a block diagram of example devices in the live broadcast system, according to some aspects of the disclosure.

FIG. 3 illustrates an example betting program enabled live broadcast system, according to some aspects of the disclosure.

FIG. 4 illustrates an example method of broadcast service, according to some aspects of the disclosure.

FIG. 5 illustrates an example method of playing a live event, according to some aspects of the disclosure.

FIG. 6 illustrates an example computer system for implementing some aspects of the disclosure or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure include apparatus, system, computer program product, and method aspects for a live sporting events broadcasting system for a betting application.

In some aspects, a betting application allows users to place wagers on various events, such as live sporting events. Conventionally, the users need to constantly juggle between the betting application and a display of the sporting events on a TV or a computer screen. This creates inconvenience because betting applications are highly sensitive to timeliness. For example, the betting application may include a betting program that asks the users to bet within 5 minutes on which team would score next. Thus, the users may need to check the TV or the computer screen for the game progress and team performance while paying attention to the betting application as the betting program approaches its closing time. This kind of watching-both-devices requirement would degrade user experience and potentially discourage the users from participating in the betting program. Thus, it would be desired to provide a live display of the sporting events in the betting application so that the users can watch the sporting events and participate in the betting program on the same screen. This makes the users feel comfortable and thus they are more likely to participate in the betting program.

In some aspects, it may be difficult to integrate the betting application with the Internet-based sports streaming services, such as ESPN®, because of the cost and the process of getting licenses to stream, as discussed above. Thus, it may be more practical to use terrestrial broadcast systems, such as the ATSC 3.0 system, to display the sporting events. However, steps may need to be taken to provide a seamless user experience using the terrestrial broadcast systems. For example, the terrestrial broadcast systems are limited to a geolocation since the range of a broadcasting station is limited. Thus, the betting application needs to know sporting events that are available in the area where the user device is located. For another example, the betting application needs to know the real-time delay of the broadcasted sporting events. This is critical because the betting application closes the betting prior to the betting condition actually occurring. If a betting program asks which team scores in the second half of a game, no one should be allowed to place a bet after the beginning of the second half of the game (or a period before the second half of the game) because otherwise one of the team may have already scored. With a delay in signal transmission and process, the betting application may miscalculate the time point to close the betting. A broadcasting system designed for the betting application that provides timing and scheduling management is needed.

In some aspects, the broadcasting system may include a scheduling server that provides scheduling information to the betting application. The scheduling information may indicate sporting events that are broadcast in a local area and start/stop times of these sporting events. Based on the scheduling information, the betting application can choose to display one or more sporting events.

In some aspects, a time of capture information may be embedded in broadcast signals so that the betting application can decode the broadcast signals and determine when certain frames of a video were captured. The betting application can then calculate a real-time delay by comparing the time of capture with a current time. With the real-time delay, the betting application can close the betting at an appropriate time point.

In some aspects, information provided to the betting application, including the scheduling information and the time of capture information, may be encrypted so that only the intended recipients are able to obtain and use the information. The betting application can request access to the information from an authorization server. The authorization server may approve and send an approval message back to the betting application. The approval message may include decryption keys needed to decrypt the information.

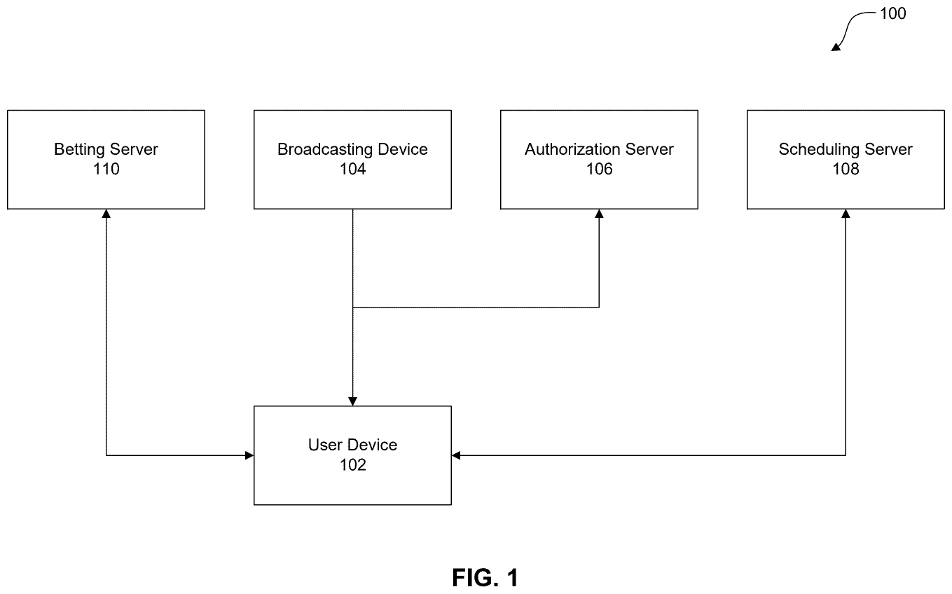

FIG. 1 illustrates an example live broadcast system 100, according to some aspects of the disclosure. The live broadcast system 100 is provided for the purpose of illustration only and does not limit the disclosed aspects. The live broadcast system 100 may include, but is not limited to, a user device 102, a broadcasting device 104, an authorization server 106, a scheduling server 108, and a betting server 110. In some aspects, the user device 102, the authorization server 106, the scheduling server 108, and the betting server 110 may include, but is not limited to, computer systems, servers, cloud systems, cloud servers, laptops, desktops, personal computers, databases, user equipment, and the like.

In some aspects, the broadcasting device 104 may include a broadcasting station, such as a TV transmitter or an ATSC 3.0 transmitter. The broadcasting device 104 may transmit signals of live sporting events in a local area. Thus, devices in the local area, such as the user device 102, can receive the signals. However, the user device 102 may not know the signals and corresponding live sporting events that are being transmitted by the broadcasting device 104. In some aspects, the user device 102 may query some information from the scheduling server 108. For example, the user device 102 may transmit a program information request to the scheduling server 108. The program information request may indicate a geolocation of the user device 102. In some aspects, the user device 102 may include a global positioning system (GPS) or a global navigation satellite system (GNSS) chipset that receives signals from satellites to determine its geolocation. The scheduling server 108 may identify live sporting events that are available in the geolocation. For example, the scheduling server 108 may identify a list of broadcasting devices, such as the broadcasting device 104, and their respective ranges. Thus, the scheduling server 108 may determine one or more broadcasting devices that cover the user device 102. Next, the scheduling server 108 may determine a list of live sporting events that are being broadcasted or will be broadcasted by the one or more broadcasting devices. For example, the scheduling server 108 may store or have access to a lookup table that lists live sporting events broadcasted by each broadcasting device. Finally, the scheduling server 108 may inform the user device 102 of the list of live sporting events. For example, the scheduling server 108 may transmit scheduling information to the user device 102. In some aspects, the scheduling information may include the list of live sporting events. In addition, the scheduling information may also include other information about each live sporting event, such as an expected start time, an expected stop time, and channel information. In some aspects, the channel information may include an ATSC 3.0 frequency or an ATSC 3.0 tuner identification (ID). In such a case, the user device 102 receives a live sporting event broadcast based on the channel information of the live sporting event, such as by tuning a receiver of the user device 102 to the ATSC 3.0 frequency.

In some aspects, the user device 102 may need to determine a real-time delay between a live sporting event and the broadcast signals. For example, a baseball player may have hit a home run at 7:00 PM, but the broadcast signals may deliver video signals of the home run hit at 7:05 PM. Thus there is a 5-minutes delay between the live sporting event and the broadcast signals. This can be due to the time for processing the video as well as the time for transmitting the broadcast signals. In some aspects, a time of capture may be embedded into the broadcast signals. For example, one or more frames in the video may correspond to the home run. Thus, the broadcasting signals may bundle the one or more frames with time stamps that correspond to the time of capturing the home run. Thus, when receiving the broadcasting signals, the user device 102 can determine when the home run happened based on the time stamps. Furthermore, the user device 102 may also determine a current time. Therefore, the user device 102 can calculate the real-time delay by subtracting the time stamps from the current time.

In some aspects, the channel information and/or the time stamps may be encrypted so that only authorized devices can obtain and use them. In some aspects, the user device 102 can be authorized by the authorization server 106. For example, the user device 102 may transmit a request to the authorization server 106. The request may indicate one or more live sporting events that the user device 102 would like to access. In response, the authorization server 106 may transmit an approval message back to the user device 102. In some aspects, the approval message may include one or more decryption keys to decrypt the channel information and/or the timestamps. Decryption keys used to decrypt the channel information and the timestamps can be the same or different.

In some aspects, a betting company running the betting application may establish a betting server 110. The betting server 110 may act similarly as the authorization server 106 and the scheduling server 108 to provide information to the user device 102. For example, the betting server 110 may provide the scheduling information to the user device 102. In addition, the betting server 100 may also provide decryption keys to decrypt the channel information and/or the time stamps.

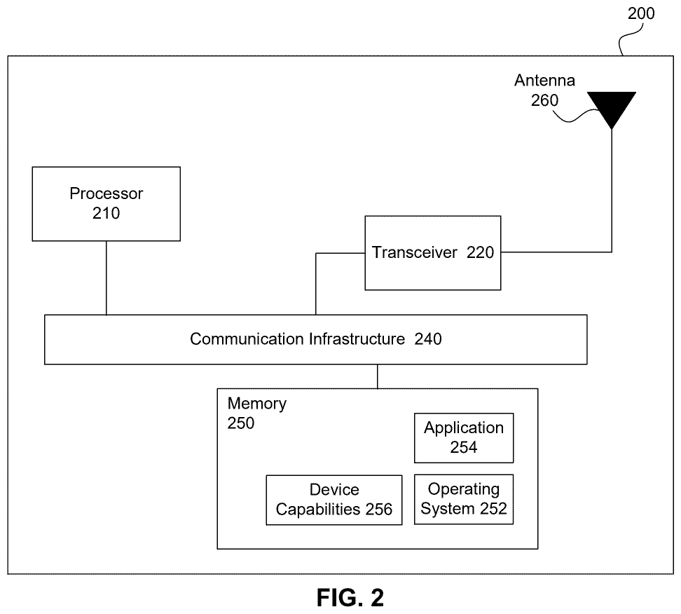

FIG. 2 illustrates a block diagram of an example electronic device 200 in the live broadcast system, according to some aspects of the disclosure. The electronic device 200 may be any of the electronic devices (e.g., the user device 102, the authorization server 106, the scheduling server 108, the betting server 110, or a combination thereof of FIG. 1) of the live broadcast system 100. The electronic device 200 includes a processor 210, one or more transceivers 220, a communication infrastructure 240, a memory 250, an operating system 252, an application 254, device capabilities 256, and antenna 260. Illustrated systems are provided as exemplary parts of electronic device 200, and electronic device 200 may include other circuit(s) and subsystem(s). Also, although the systems of electronic device 200 are illustrated as separate components, the aspects of this disclosure may include any combination of these, e.g., less, or more components.

The memory 250 may include random access memory (RAM) and/or cache, and may include control logic (e.g., computer software) and/or data. The memory 250 may include other storage devices or memory. According to some examples, the operating system 252 may be stored in the memory 250. The operating system 252 may manage transfer of data from the memory 250 and/or the one or more applications 254 to the processor 210 and/or the one or more transceivers 220. In some examples, the operating system 252 maintains one or more network protocol stacks (e.g., Internet protocol stack, cellular protocol stack, and the like) that may include a number of logical layers. At corresponding layers of the protocol stack, the operating system 252 includes control mechanisms and data structures to perform the functions associated with that layer.

According to some examples, the application 254 may be stored in the memory 250. The application 254 may include applications (e.g., user applications) used by the electronic device 200 and/or a user of the electronic device 200. In some aspects, the device capabilities 256 may be stored in the memory 250.

The electronic device 200 may also include the communication infrastructure 240. The communication infrastructure 240 provides communication between, for example, the processor 210, the one or more transceivers 220, and the memory 250. In some implementations, the communication infrastructure 240 may be a bus.

The processor 210, alone, or together with instructions stored in the memory 250 performs operations enabling electronic device 200 of the system 100 to implement the live sporting events broadcasting system, as described herein. Alternatively, or additionally, the processor 210 can be “hard coded” to implement the live sporting events broadcasting system, as described herein.

The one or more transceivers 220 transmit and receive communications signals support mechanisms for implementing the live sporting events broadcasting system. Additionally, the one or more transceivers 220 transmit and receive communications signals that support mechanisms for measuring communication link(s), generating and transmitting system information and data, and receiving the system information and data. According to some aspects, the one or more transceivers 220 may be coupled to the antenna 260 to wirelessly transmit and receive the communication signals. The antenna 260 may include one or more antennas that may be the same or different types and can form one or more antenna ports. In some aspects, the antenna 260 can be replaced or used in combination with wired communication interferences, such as Ethernet, Universal Serial Bus (USB), serial port, serial advanced technology attachment (SATA), and fiber optic interferences. The one or more transceivers 220 allow electronic device 200 to communicate with other devices that may be wired and/or wireless. In some examples, the one or more transceivers 220 may include processors, controllers, radios, sockets, plugs, buffers, and like circuits/devices used for connecting to and communication on networks. According to some examples, the one or more transceivers 220 include one or more circuits to connect to and communicate on wired and/or wireless networks.

According to some aspects of this disclosure, the one or more transceivers 220 may include a TV subsystem, an ATSC subsystem, a cellular subsystem, a WLAN subsystem, and/or a Bluetooth^{TM} subsystem, each including its own radio transceiver and protocol(s) as will be understood by those skilled in the arts based on the discussion provided herein. In some implementations, the one or more transceivers 220 may include more or fewer systems for communicating with other devices.

In some examples, the one or more the transceivers 220 may include one or more circuits (including a WLAN transceiver) to enable connection(s) and communication over WLAN networks such as, but not limited to, networks based on standards described in IEEE 802.11.

Additionally, or alternatively, the one or more the transceivers 220 may include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, the transceiver 220 may include a Bluetooth™ transceiver. Additionally, the one or more the transceivers 220 may include one or more circuits (including a cellular transceiver) for connecting to and communicating on cellular networks.

Furthermore, the one or more transceiver 220 may include one or more circuits to enable connection(s) and communication based on terrestrial broadcast protocols including analog TV protocols, digital TV protocols, ATSC 3.0 protocols, and so on. In some aspects, the one or more transceivers 220 may include modules that process video signals received. For example, the modules may include an ATSC tuner, a demodulator, a decoder, and other modules that correspond to the terrestrial broadcast protocols.

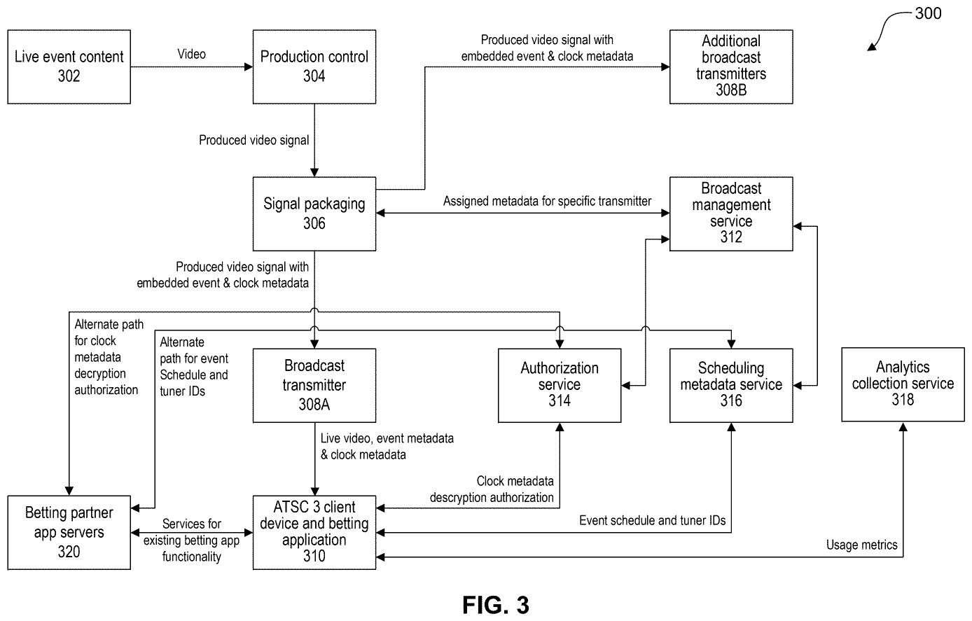

As discussed in more detail below with respect to FIGS. 3-6, processor 210 may implement different mechanisms for implementing the live sporting events broadcasting system as discussed with respect to the live broadcast system 100 of FIG. 1.

FIG. 3 illustrates an example betting program enabled live broadcast system 300, according to some aspects of the disclosure. The system 300 is provided for the purpose of illustration only and does not limit the disclosed aspects. The system 300 may include, but is not limited to, a live event content 302, a production control 304, a signal packing 306, broadcast transmitters 308A and 308B, a client device 310, a broadcast management server 312, an authorization server 314, a scheduling metadata server 316, an analytics collection server 318, and betting partner application servers 320. In some aspects, the client device 310, the broadcast management server 312, the authorization server 314, the scheduling metadata server, the analytics collection server 318, and the betting partner application servers 320 may include, but is not limited to, computer systems, servers, cloud systems, cloud servers, laptops, desktops, personal computers, databases, user equipment, and the like.

In some aspects, the live event content 302 may be a live event itself, such as a soccer game. The production control 304 may include facilities that capture the live event and produce visual and audio content of the live event. For example, the production control 304 may include a broadcasting truck or onsite production devices. In some aspects, the production control 304 may combine the visual and audio content into a video signal and transmit the video signal to the signal packaging 306. In some aspects, the signal packaging 306 may be onsite of the live event content and thus in proximity of the production control 304. In such a case, the production control 304 may transmit the video signal to the signal packaging 306 via a wired connection. In other aspects, the signal packaging 306 may be remotely located or on the cloud. In such a case, the production control 304 may transmit the video signal to the signal packaging 306 via the Internet.

In some aspects, the signal packaging 306 may insert event time information into the video signal. For example, the signal packaging 306 may insert an actual start time or a start indicator that indicates the video signal contains the live event. For example, the start indicator may be a binary number that indicates the live event with “1” and no live event with “0.” Similarly, the signal packaging 306 may insert an actual stop time or a stop indicator that indicates the video signal no longer contains the live event. In some aspects, the actual start time/the start indicator and the actual stop time/the stop indicator may be inserted into the video signal as metadata. Thus, the metadata is embedded in the video signal. In some aspects, the production control 304 may determine and insert the actual start time/the start indicator and the actual stop time/the stop indicator into the video signal before transmitting it to the signal packaging 306. In such a case, the video signal received by the signal packaging 306 already includes the embedded metadata.

In some aspects, the signal packing 306 may transmit the video signal with the embedded metadata to the broadcast transmitters 308A and 308B. It is worth noting that the signal packing 306 may transmit to additional broadcast transmitters not shown here. In some aspects, the broadcast transmitters 308A and 308B may be similar to the broadcasting device 104 in FIG. 1. In some aspects, the signal packaging 306 may selectively transmit to one or more broadcast transmitters, such as the broadcast transmitters 308A and 308B. For example, the signal packaging 306 may determine that the transmitters 308A and 308B are within a predetermined distance of the live event or that the live event is popular in locations of the transmitters 308A and 308B.

In some aspects, the broadcast management server 312, which can also be referred to as a broadcast management service, may control the transmission of the signal packaging 306. For example, the broadcast management server 312 may determine which broadcast transmitters the signal packaging 306 transmits to. In some aspects, the signal packaging 306 may receive video signals from a plurality of production controls, including the production control 304. The broadcast management server 312 may determine which video signal to be transmitted by the signal packaging 306 and thus go into the broadcast. In some aspects, the broadcast management server 312 may determine metadata to be included in the video signal that is transmitted to the broadcast transmitters 308A and 308B. For example, the broadcast management server 312 may determine to include the metadata in the video signal transmitted to the broadcast transmitter 308A. In such a case, the signal packaging 306 may embed the metadata into the video signal to be transmitted to the broadcast transmitter 308A as discussed above. The broadcast management server 312 may also determine not to include the metadata in the video signal transmitted to the broadcast transmitter 308B. In such a case, the signal packing 306 transmits the video signal without embedded metadata to the broadcast transmitter 308B. In some aspects, the broadcast management server 312 may also manage operations of the scheduling metadata server 316 and the authorization server 314 discussed below.

In some aspects, the client device 310, which can also be referred to as an ATSC 3.0 client device, may receive the video signal from the broadcast transmitter 308A. The client device 310 may be similar to the user device 102 in FIG. 1. The client device 310 may also include a betting application that provides betting programs for users of the client device 310 to make bets. In addition, the betting application may also display live events, such as the live events of the live event content 302. In some aspects, the client device 310 requires scheduling information to receive the video signal from the broadcast transmitter 308A. For example, the client device 310 needs to know when the live event is being broadcast and when the live event ends. In addition, the client device 310 needs to know the tuner ID, such as an ATSC 3.0 tuner ID, or the frequency, such as an ATSC 3.0 frequency, so that the client device 310 can configure its receiver, such as the transceiver 220 in FIG. 2, to receive the video signal from the broadcast transmitter 308A. Thus, the scheduling information may include an expected start time, an expected stop time, and channel information of the live events, wherein the channel information includes the tuner ID or the frequency. In some aspects, the client device 310 queries the scheduling information from the scheduling metadata server 316. The scheduling metadata server 316 may also be referred to as a scheduling metadata service and may be similar to the scheduling server 108 in FIG. 1.

In some aspects, the client device 310 may transmit a program information request to the scheduling metadata server 316. The program information request may indicate a geolocation of the client device 310. For example, the geolocation may be a GPS coordinate, an address, or other information that corresponds to the current location of the client device 310. The client device 310 may determine the geolocation based on a location chipset, such as a GPS chip and a GNSS chip. Furthermore, the client device may use a Broadcast Position System (BPS) in addition to or instead of the location chipset when the GPS signals are weak or unavailable. For example, the client device 310 may receive signals from one or more broadcast transmitters, such as the broadcast transmitters 308A and 308B. The signals may include time and location information so that the client device 310 may determine distances to the one or more broadcast transmitters. The client device 301 may then determine its own location based on triangulation or other methods. In addition, the user of the client device 310 may determine the geolocation and enter it into the client device 310. In some aspects, after receiving the program information request, the scheduling metadata server 316 may determine a list of live events that are available to the client device 310. Similarly as discussed in FIG. 1 above, the scheduling metadata server 316 may determine the list of live events based on locations of the broadcast transmitters, such as the broadcast transmitter 308A, and live events that are currently being broadcasted or will be broadcasted in the future by these broadcast transmitters. The scheduling metadata server 316 then transmits the scheduling information back to the client device 310.

In some aspects, the client device 310 may select one or more live events to display in the betting application. For example, the scheduling information may correspond to a plurality of live events. In such a case, the client device 310 may rank the plurality of live events based on various factors, such as popularity, distances to the client device 310, history of similar events that the user watched in the past or within a predetermined time window, or user instructions. The client device 310 may then select the one or more live events that are ranked higher than other live events in the plurality of live events. In some aspects, for each of the selected one or more live events, the client device 310 may determine the expected start time of the live event based on the scheduling information and start to monitor the video signals from the broadcast transmitter 308A based on the channel information. For example, the client device 310 may configure its receiver to receive video signals in the ATSC 3.0 frequency corresponding to the live event, as indicated in the channel information. The client device 310 can continuously monitor the video signals received from the broadcast transmitter 308A to determine: (1) whether the video signals are strong enough to decode and display the live event; and (2) whether the video signals contain the actual live event. Regarding (1), the client device 310 can analyze the signal quality of the video signals and determine whether the video signals are strong enough. For example, the signal quality may include, but not limited to, signal-to-noise ratio (SNR), received signal strength indicator (RSSI), signal-to-interference-plus-noise ratio (SINR), and other factors. The client device 310 may determine that the signal quality is higher than a predetermined threshold and thus the video signals are strong enough. Otherwise, the client device 310 may wait and keep monitoring the video signals until they are strong enough. In some aspects, the client device 310 monitors the video signals on a rolling basis. For example, the client device 310 may monitor the video signals in a sliding window. The size of the slide window may be a predetermined period, such as 2 seconds. If an average signal quality of the video in the past 2 seconds, i.e., within the sliding window, is higher than the predetermined threshold, the client device 310 determines that the video signals are strong enough. Regarding (2), the client device may determine whether the video signals actually contain the live event based on the actual start time or the start indicator embedded in the video signals as discussed above. For example, the actual start time may indicate that the live event actually starts at 7:00 PM. In some aspects, the actual start time may be different from the expected start time discussed above because the live event may be postponed or delayed. Thus, the actual start time that comes with the video signals gives a more actual time point when the live event starts. For another example, the start indicator may indicate whether the video signals that are being transmitted together with the start indicator contain the live event. Specifically, the start indicator may be a binary indicator and when the start indicator contains “1”, the client device 310 may determine that the video signals contain the live event. In either case, once the client device 310 determines that the video signals are strong enough and contain the live event, the client device 310 may start playing the live event in the betting application. In some aspects, the client device 310 may stop playing the live event once the live event ends. For example, the client device 310 may determine that the live event has ended based on the actual stop time or the stop indicator. Specifically, the actual stop time may indicate that the live event has ended at 10:00 PM, which was 10 minutes ago, or the stop indicator may indicate that the video signals no longer contain the live event. In either case, the client device 310 may stop playing the live event.

In some aspects, the client device 310 may also need to calculate a real-time delay of the video signals. For example, the production control 304 may provide timestamps of the video signals. The timestamps may be inserted into the video signals and indicate times of capture for certain frames. Specifically, the time stamps can indicate that a frame is captured at 7:31 PM. The production control 304 can insert the time stamps into the video signals transmitted to the signal packaging 306. In some aspects, the time stamps are included in the metadata together with the other information, such as the actual start time/start indicator and the actual stop time/stop indicator. Once the client device 310 receives the timestamps, the client device 310 compares the timestamps with a current time to determine a real-time delay. For example, the current time may be 7:35 PM and the timestamp indicates 7:31 PM. In such a case, the real-time delay is the difference between the two time points, which is 4 minutes. The real-time delay may be due to processing time need for devices including the production control 304, the signal packaging 306, and the broadcast transmitter 308A. In addition, it also takes time for the video signals to arrive at the client device 310. In either case, the betting application of the client device 310 may adjust the betting programs based on the real-time delay. For example, if a betting program asks the user to bet on whether a team will score in the second half of a game, the rule may be that the betting program closes 10 minutes prior to the second half starts. The game played on the betting application may show that the second half starts in 12 minutes. Thus, it appears that the betting application should close the betting program in 2 minutes. However, due to the 4-minutes real-time delay, it is only 8 minutes until the second half begins. Thus, the betting program should have been closed 2 minutes ago. Thus, by considering the real-time delay, the betting application can determine a correct time to close or open betting programs.

In some aspects, the client device 310 may need authorization to play the live event. For example, the channel information provided by the scheduling metadata server 316 may be encrypted and authorized devices are provided with decryption keys to decode the channel information. In addition, the metadata embedded in the video signals may also be encryption with the same or different decryption keys. The client device 310 may request for authorization from the authorization server 314, which is similar to the authorization server 106 in FIG. 1 and can also be referred to as authorization service. In some aspects, the client device 310 may transmit a request to the authorization server 314. The request may indicate the metadata embedded in the video signals. For example, the request may indicate an event ID of the live event. In response, the authorization server 314 may generate and transmit an approval message to the client device 310. In some aspects, the approval message may include one or more decryption keys used to decrypt the metadata corresponding to the live event received from the broadcast transmitter 308A. Similarly, the request may also indicate a demand for the channel information. In such a case, the approval message may include one or more decryption keys used to decrypt the channel information received from the scheduling metadata server 316. In some aspects, the client device may transmit a separate request for the channel information. In such a case, the authorization server may transmit a separate approval message regarding the one or more decryption keys used to decrypt the channel information.

In some aspects, a betting partner, such as an owner of the betting application, may establish and operate the betting partner application servers 320. The betting partner application servers 320 may operate similarly to the scheduling metadata server 316 and the authorization server 314. For example, the betting partner application servers 320 may receive the scheduling information from the scheduling metadata server 316 and transmit it to the client device 310. Thus, the client device 310 receives the scheduling information indirectly from the scheduling metadata server 316 via the betting partner application servers 320. In such a case, the betting partner application servers 320 can control what is provided to the client device 310. For example, instead of providing all the live events available in the area of the client device 310, the betting partner application servers 320 may filter out one or more live events that are not suitable for the betting application. In addition, the betting partner application servers 320 provide decryption keys to the client device to decrypt the metadata and the channel information. Similarly, the client device 310 receives the decryption keys indirectly from the scheduling metadata server 316 via the betting partner application servers 320. In this way, the betting partner application servers 320 may control whether the client device 310 has access to certain information.

In some aspects, the analytics collection service 318 collects performance information from the client device 310. For example, the user of the client device 310 may take a survey regarding the experience of using the betting application. The client device 310 may transmit results of the survey to the analytics collection service 318. For another example, the client device 310 may monitor the video signals received and determine an overall signal quality in a period of time. The period of time may be an entire period of the live events, half time of the live events, or other predetermined time periods. The client device 310 may transmit the overall signal quality to the analytics collection service 318. In either case, the analytics collection service 318 may use information collected from the client device 310, such as the survey result and the overall signal quality, to make adjustment in future broadcasting so that the overall performance of the broadcasting system is improved.

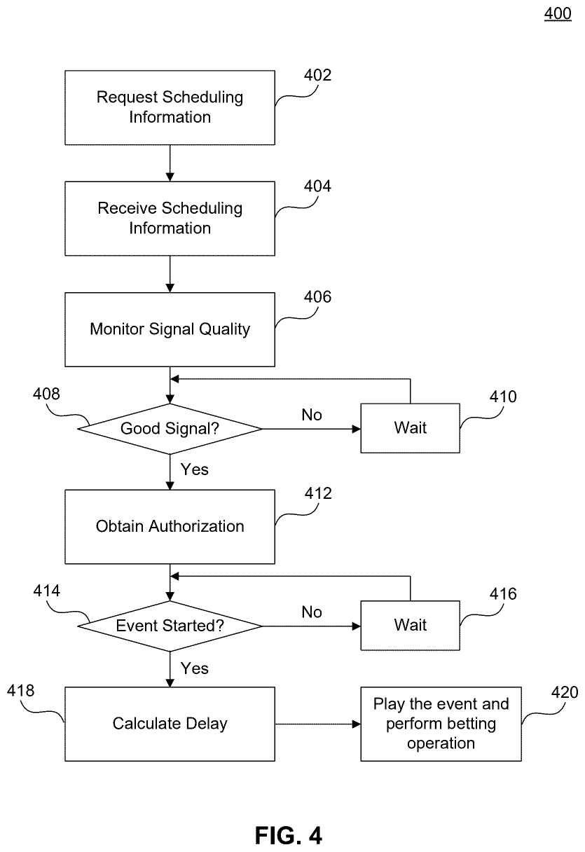

FIG. 4 illustrates an example method 400 of broadcast service, according to some aspects of the disclosure. The method 400 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

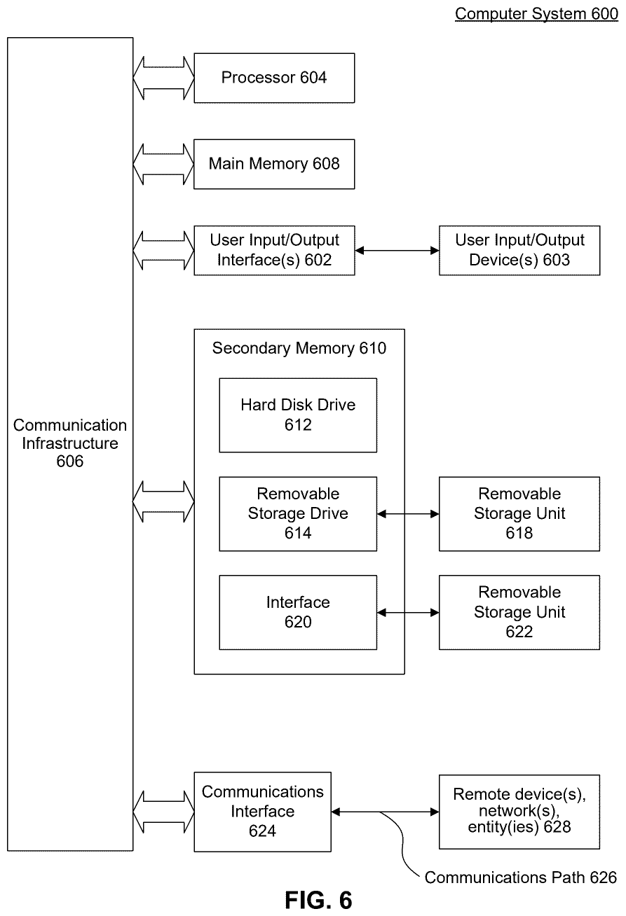

As a convenience and not a limitation, FIG. 4 may be described with regard to elements of FIGS. 1-3 and 6. The example method 400 may represent the operation of devices (e.g., the user device 102 of FIG. 1 and the client device 310 of FIG. 3) implementing the live sporting events broadcasting system for a betting application. The example method 400 may also be performed by computer system 600 of FIG. 6. But the example method 400 is not limited to the specific aspects depicted in those figures and other systems may be used to perform the method, as will be understood by those skilled in the art. It is to be appreciated that not all operations may be needed, and the operations may not be performed in the same order as shown in FIG. 4.

At 402, user device, such as the user device 102 or the client device 310, may request scheduling information from a scheduling server, such as the scheduling server 108 or the scheduling metadata server 316. For example, the user device may transmit a request to the scheduling server. In some aspects, the request may indicate a geolocation of the user device as discussed above.

At 404, the user device may receive the scheduling information from the scheduling server. In some aspects, the scheduling information may include expected start times, expected stop times, and channel information of one or more live events that are available in the geolocation of the user device. As discussed above, the scheduling server may determine a list of live events that the user device is able to receive in the geolocation and transmit the scheduling information of the list of the live events to the user device.

At 406, the user device may monitor signal quality of video signals. In some aspects, the user device may select one or more live events from the list of live events. For example, the user device may determine that the one or more live events are suitable for betting programs provided by a betting application installed on the user device. The user device then extracts the channel information of the one or more live events and monitors the signal quality of each frequency of the one or more live events. In some aspects, the channel information may be encrypted. In such a case, the user device may request access to the channel information from an authorization server, such as the authorization servers 106 and 314. As discussed above, the user device may receive a first approval message indicating one or more decryption keys used to decrypt the channel information. In some aspects, the user device may start monitoring the signal quality at the expected start time of a live event.

At 408, the user device may determine whether the signal quality of a live event is good. For example, the signal quality can be an SNR value, an RSSI value, or an SINR value. If the signal quality is lower than a predetermined threshold, the user device may determine that the signal quality of the video signals is not good enough and the control moves to 410. The user device waits a predetermined period of time and checks again whether the signal quality is good enough. If the signal quality is higher than the predetermined threshold, the user device may determine that the signal quality of the video signals is good enough and the control moves to 412.

At 412, the user device may obtain authorization to access metadata embedded in the video signals. In some aspects, the user device may transmit a request for accessing the metadata to the authorization server. As similarly discussed above, the authorization server may transmit a second approval message to the user device indicating decryption keys used to decrypt the metadata. In some aspects, the user device may request for accessing the channel information, as discussed in 406, and accessing for the metadata in one request. In such a case, the authorization device may combine the first and the second approval messages into a bundle approval message and transmit the bundle approval message to the user device. Therefore, the user device may have received the decryption keys used to decrypt the metadata at the step 406 and the step 412 can be skipped.

At 414, the user device determines whether the live event has started. In some aspects, the live event may be postponed or delayed for various reasons, such as weather, equipment preparation, or other onsite situations. Thus, the user device wants to know when the live event actually kicks off. As discussed above, the metadata embedded in the video signal may include an actual start time or a start indicator. Since the user device obtained the authorization and decryption keys of the metadata, the user device may decode the metadata and determine whether the live event has started based on the metadata. If the user device determines that the live event has not started yet, the control moves to 416 and the user device waits for an event pending period to check again. If the user device determines that the live event has started, the control moves to 418.

At 418, the user device calculates a real-time delay in the video signal. As discussed above, the video signals may include metadata that includes a timestamp indicating a time of capture of the video signals. The user device may retrieve the timestamp when decoding the metadata. Furthermore, the user device may determine a current time based on a time service. Finally, the user device can determine the real-time delay based on the time of capture and the current time. For example, the user device may determine the real-time delay by subtracting the time of capture from the current time.

At 420, the user device may play the live event and perform betting operations. In some aspects, the user device determines that the signal quality is good at 408 and that the live event has started at 414. In such a case, the user device may decode the video signals and display the live event in the betting application. In addition, the betting application may perform the betting operations by offering one or more betting programs in the betting application while displaying the live event. In some aspects, the one or more betting programs are in association with the live event. For example, the live event may be a soccer game and the one or more betting programs may ask the user to bet whether and/or which team will score in the live event. As discussed above, the one or more betting programs may have time requirements. In such a case, the betting application considers the real-time delay when opening or closing the betting programs. For example, if a betting program is supposed to close 10 minutes after the live event starts and the real-time delay is 3 minutes, the betting application closes the betting program when displaying 7 minutes into the game so that the real-time delay is factored in.

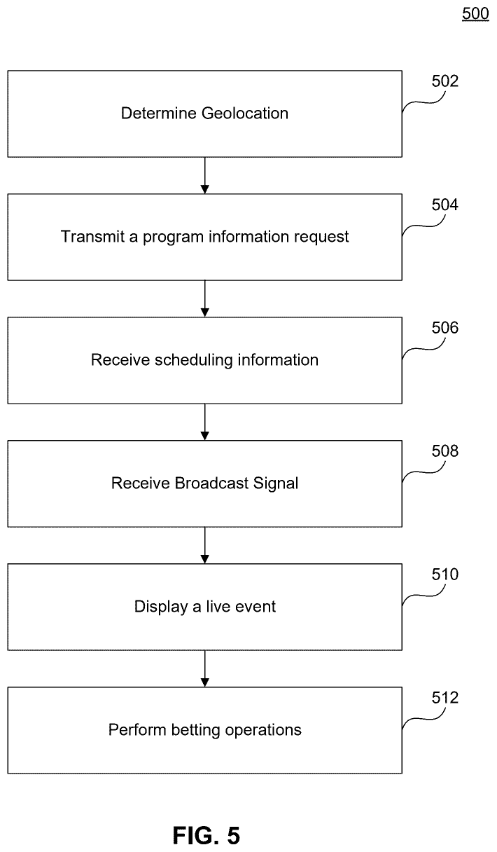

FIG. 5 illustrates an example method 500 of playing a live event, according to some aspects of the disclosure. The method 500 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

As a convenience and not a limitation, FIG. 5 may be described with regard to elements of FIGS. 1-3 and 6. The example method 500 may represent the operation of devices (e.g., the user device 102 of FIG. 1 and the client device 310 of FIG. 3) implementing the live sporting events broadcasting system for a betting application. For example, the example method 500 may represent the operation of a betting application of the devices, such as the betting application of the user device 102 or the betting application of the client device 310. The example method 500 may also be performed by computer system 600 of FIG. 6. But the example method 500 is not limited to the specific aspects depicted in those figures and other systems may be used to perform the method, as will be understood by those skilled in the art. It is to be appreciated that not all operations may be needed, and the operations may not be performed in the same order as shown in FIG. 5.

At 502, a betting application of a user device, such as the user device 102 or the client device 310, may determine a geolocation of the user device. In some aspects, the user device may include a chipset for location services, such as a GPS chip or a GNSS chip. In such a case, the betting application may configure the user device to communicate with a satellite to determine its geolocation. The geolocation may be a coordinate that includes a longitude and a latitude. The geolocation can also be a street address, a building name, a city name, or other things that are related to the geolocation of the user device.

At 504, the betting application of the user device may transmit a program information request to a scheduling server, such as the scheduling server 108 or the scheduling metadata server 316. For example, the betting application may configure a transceiver of the user device, such as the transceiver 220, to transmit the program information request. In some aspects, the request may indicate the geolocation of the user device as discussed above.

At 506, the betting application of the user device may receive scheduling information of a live event in the geolocation from the scheduling server. For example, the betting application may configure the transceiver of the user device to receive the scheduling information. In some aspects, the scheduling server may identify a list of events that are available in the geolocation of the user device. The scheduling server may transmit scheduling information of one or more live events on the list and the one or more live events include the live event. In some aspects, the scheduling information may include an expected start time, an expected stop time, and channel information of the live event. The channel information may include an ATSC 3.0 frequency or an ATSC 3.0 tuner ID. In some aspects, the channel information may be encrypted. In such a case, the user device may request for access the channel information from an authorization server, such as the authorization servers 106 and 314, as discussed above.

At 508, the betting application of the user device may receive a broadcast signal based on the scheduling information. For example, the betting application may configure the transceiver of the user device to receive the broadcast signal. In some aspects, a broadcast transmitter, such as the broadcast device 104 or the broadcast transmitter 308A, may transmit the broadcast signal on the ATSC 3.0 frequency that includes video signals of the live event. The user device may tune its receiver, such as the transceiver 220, to the ATSC 3.0 frequency to receive the broadcast signal.

In some aspects, the broadcast signal may include metadata. The metadata may include an actual start time/start indicator or an actual end time/end indicator. In such a case, the user device may determine that the live event has started based on the actual start time or the start indicator and thus start displaying the live event. On the other hand, the user device may determine that the live event has ended based on the actual end time or the end indicator and thus stop displaying the live event. In some aspects, the metadata may further include a timestamp indicating a time of capture. The user device may determine a real-time delay based on the timestamp and a current time. In this way, the user device may perform one or more betting operations, such as betting programs, based on the delay.

In some aspects, the metadata are encrypted. In such a case, the user device may transmit a request for accessing the metadata to the authorization server. The authorization server may transmit an approval message to the user device, which includes one or more decryption keys used to decrypt the metadata.

At 510, the betting application of the user device may display the live event based on the broadcast signal.

At 512, the betting application of the user device may perform one or more betting operations in association with the live event. In some aspects, the one or more betting operations may offer one or more betting programs. The live event may be a soccer game. In such a case, the one or more betting programs may ask the user of the betting application which team will win the soccer game.

Various aspects may be implemented, for example, using one or more well-known computer systems, such as computer system 600 shown in FIG. 6. One or more computer systems 600 may be used, for example, to implement any of the aspects discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 6. In particular, aspects can operate with software, hardware, and/or operating system implementations other than those described herein.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described can include a particular feature, structure, or characteristic, but every embodiment can not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

Some non-limiting Examples of various aspects are provided below.

Example 1 may include a user device comprising a memory and at least one processor coupled to the memory. That at least one processor is configured to determine a geolocation of the user device and transmit a program information request to a scheduling server. The program information request indicates the geolocation. That at least one processor is further configured to receive scheduling information of a live event in the geolocation from the scheduling server and receive a broadcast signal based on the scheduling information. Finally, that at least one processor is further configured to display the live event based on the broadcast signal through a betting application at the user device and perform one or more betting operations using the betting application in association with the live event.

Example 2 may include a method of computer-implemented method for a betting application of a user device. The method includes determining a geolocation of the user device and transmitting a program information request to a scheduling server. The program information request indicates the geolocation. The method further includes receiving scheduling information of a live event in the geolocation from the scheduling server and receiving a broadcast signal based on the scheduling information. Finally, the method further includes displaying the live event based on the broadcast signal and performing one or more betting operations using the betting application in association with the live event.

Example 3 may include a non-transitory computer-readable medium (CRM) comprising instructions to, upon execution of the instructions by one or more processors of a user device, cause a betting application of the user device to perform operations. The operations include determining a geolocation of the user device and transmitting a program information request to a scheduling server. The program information request indicates the geolocation. The operations further include receiving scheduling information of a live event in the geolocation from the scheduling server and receiving a broadcast signal based on the scheduling information. Finally, the operations further include displaying the live event based on the broadcast signal and performing one or more betting operations using the betting application in association with the live event.

What is claimed is:

1. A user device, comprising:
a memory; and
at least one processor coupled to the memory and configured to:
determine a geolocation of the user device;
transmit a program information request to a scheduling server, wherein the program information request indicates the geolocation;
receive scheduling information of a live event in the geolocation from the scheduling server;
receive a broadcast signal based on the scheduling information;
display, through a betting application at the user device, the live event based on the broadcast signal; and
perform one or more betting operations using the betting application in association with the live event.

2. The user device of claim 1, wherein the scheduling information includes an expected start time, an expected stop time, and channel information of the live event.

3. The user device of claim 2, wherein the channel information includes an advanced television systems committee (ATSC) 3.0 frequency or an ATSC 3.0 tuner identification (ID).

4. The user device of claim 2, wherein:
the broadcast signal includes metadata,
the metadata include an actual start time or an actual stop time of the live event, and
the at least one processor is further configured to:
display the live event based on the actual start time; and
stop displaying the live event based on the actual stop time.

5. The user device of claim 4, wherein the at least one processor is further configured to:
determine a timestamp indicating a time of capture based on the metadata;
determine a current time;
determine a delay based on the time of capture and the current time; and
perform the one or more betting operations based on the delay.

6. The user device of claim 4, wherein the at least one processor is further configured to:
transmit a request for accessing the metadata to an authorization server;
receive an approval message from the authorization server, wherein the approval message includes one or more decryption keys; and
retrieve the metadata from the broadcast signal based on the one or more decryption keys.

7. The user device of claim 1, wherein the at least one processor is further configured to:
monitor a signal quality of the broadcast signal based on the scheduling information;
determine that the signal quality is above a threshold; and
display the live event in response to determining that the signal quality is above the threshold.

8. A computer-implemented method for a betting application of a user device, comprising:
determining a geolocation of the user device;
transmitting a program information request to a scheduling server, wherein the program information request indicates the geolocation;
receiving scheduling information of a live event in the geolocation from the scheduling server;
receiving a broadcast signal based on the scheduling information;
displaying the live event based on the broadcast signal; and
performing one or more betting operations using the betting application in association with the live event.

9. The computer-implemented method of claim 8, wherein the scheduling information includes an expected start time, an expected stop time, and channel information of the live event.

10. The computer-implemented method of claim 9, wherein the channel information includes an advanced television systems committee (ATSC) 3.0 frequency or an ATSC 3.0 tuner identification (ID).

11. The computer-implemented method of claim 9, wherein:
the broadcast signal includes metadata,
the metadata include an actual start time or an actual stop time of the live event, and
the computer-implemented method further comprises:
displaying the live event based on the actual start time; and
stopping displaying the live event based on the actual stop time.

12. The computer-implemented method of claim 11, further comprising:
determining a timestamp indicating a time of capture based on the metadata;
determining a current time;
determining a delay based on the time of capture and the current time; and
performing the one or more betting operations based on the delay.

13. The computer-implemented method of claim 11, further comprising:
transmitting a request for accessing the metadata to an authorization server;
receiving an approval message from the authorization server, wherein the approval message includes one or more decryption keys; and
retrieving the metadata from the broadcast signal based on the one or more decryption keys.

14. The computer-implemented method of claim 8, further comprising:
monitoring a signal quality of the broadcast signal based on the scheduling information;
determining that the signal quality is above a threshold; and
displaying the live event in response to determining that the signal quality is above the threshold.

15. A non-transitory computer-readable medium (CRM) comprising instructions to, upon execution of the instructions by one or more processors of a user device, cause a betting application of the user device to perform operations, the operations comprising:
determining a geolocation of the user device;
transmitting a program information request to a scheduling server, wherein the program information request indicates the geolocation;
receiving scheduling information of a live event in the geolocation from the scheduling server;
receiving a broadcast signal based on the scheduling information;
displaying the live event based on the broadcast signal; and
perform one or more betting operations using the betting application in association with the live event.

16. The non-transitory CRM of claim 15, wherein the scheduling information includes an expected start time, an expected stop time, and channel information of the live event.

17. The non-transitory CRM of claim 16, wherein the channel information includes an advanced television systems committee (ATSC) 3.0 frequency or an ATSC 3.0 tuner identification (ID).

18. The non-transitory CRM of claim 15, wherein:
the broadcast signal includes metadata,
the metadata include an actual start time or an actual stop time of the live event, and
the operations further comprise:
displaying the live event based on the actual start time; and
stopping displaying the live event based on the actual stop time.

19. The non-transitory CRM of claim 18, wherein the operations further comprise:
determining a timestamp indicating a time of capture based on the metadata;
determining a current time;
determining a delay based on the time of capture and the current time; and
performing the one or more betting operations based on the delay.

20. The non-transitory CRM of claim 15, wherein the operations further comprise:
transmitting a request for accessing the metadata to an authorization server;
receiving an approval message from the authorization server, wherein the approval message includes one or more decryption keys; and
retrieving the metadata from the broadcast signal based on the one or more decryption keys.
